(19) United States
(12) Patent Application Publication
(10) Pub. No.: US 2024/0279363 A1
(43) Pub. Date: Aug. 22, 2024

(54) METHOD FOR MANUFACTURING GELATINISED BLENDS OF THERMALLY MODIFIED STARCHES

(71) Applicant: ROQUETTE FRERES, Lestrem (FR)

(72) Inventor: Solène BOCK, LAMBERSART (FR)

(21) Appl. No.: 18/565,860

(22) PCT Filed: Jun. 10, 2022
(86) PCT No.: PCT/FR2022/051109

§ 371 Date: Nov. 30, 2023

(30) Foreign Application Priority Data
Jun. 10, 2021 (FR) FR2106121

(51) Int. Cl. C08B 30/12

(52) U.S. Cl. CPC C08B 30/12

(57) ABSTRACT

The invention relates to a method for preparing a gelatinized blend of at least two heat-modified starches, wherein the starches are starches of different botanical origins, which comprises the steps consisting in:
1. Preparing a starch milk containing at least two starches of distinct botanical origins,
2. Treating the milk thus obtained under alkaline conditions and then dehydration and heat treatment for a time and at a temperature making it possible to obtain a blend of heat-modified starches,
3. Pregelatinizing said blend using a method that causes a break in the granular structure of the starches.

The invention relates to a method for producing a blend of at least two heat-modified gelatinized starches, wherein the starches are starches of different botanical origins, this method consisting in blending said starches of different botanical origins before performing the actual thermal treatment, then of gelatinizing the heat-modified blend thus obtained.

More particularly, the invention relates to a method for producing a gelatinized blend of heat-modified potato starch and waxy corn starch.

Such blends of at least two heat-modified starches make it possible:
to reinforce their viscosity properties while retaining the texturizing properties expressed by the blend of heat-modified starches prepared from a starch derived from a single botanical origin, and
to improve their solubility properties.

Such heat-modified starches then have a use as thickeners and texturizing agents in numerous food applications, mainly in instant soups, sauces, vinaigrettes, desserts, dairy products, and baking supplies.

### FIELD OF THE INVENTION

Synthesized biochemically, a source of carbohydrates, starch is one of the most widespread organic materials in the plant kingdom, where it constitutes organisms' nutrient reserves.

Starches have always been used in the food industry, not only as a nutritional ingredient but also for their technical properties, as a thickening agent, binder, stabilizer or gelling agent.

For example, native starches are used in preparations requiring cooking. Corn starch, especially, forms the basis of “powders for flan”.

Since it is rich in amylose (around 25%), it retrogrades and therefore gels strongly. It makes it possible to obtain firm flans after cooking and cooling.

It is also suitable for custards.

However, these cannot be used in pastries intended to be frozen since, on defrosting, the phenomenon of syneresis, which is reflected in the expulsion of water, destroys the texture of the custard.

Thus, in its native state, starch has limited applicability due to syneresis, but also due to:
its low resistance to shear stresses and to heat treatments,
its high retrogradation,
its limited processability, and
its low solubility in common organic solvents.

Thus, in order to meet today's demanding technical requirements, the properties of starch have to be optimized by various methods known as “modification”.

These main modifications therefore aim to adapt the starch to the technical constraints resulting from cooking, but also from freezing/thawing, from appertization or sterilization, and to make it compatible with modern food (microwaves, instant meals, “high temperatures”, etc.).

Starch modification therefore aims to correct one or more of the abovementioned defects, thereby improving its versatility and meeting the needs of consumers.

Techniques for modifying starch have generally been classified into four categories: physical, chemical, enzymatic and genetic, the ultimate goal being to produce various derivatives with optimized physicochemical properties.

Chemical and physical modifications are most commonly implemented.

Chemical treatment consists of introducing functional groups into the starch, which alters its physicochemical properties in a noteworthy manner. Indeed, such modifications of granular native starches profoundly alter their behavior in terms of gelatinization, bonding and retrogradation.

Generally, these modifications are made by chemical derivatization, such as esterification, etherification, crosslinking or grafting.

However, chemical modifications are less sought-after by consumers in food applications (also for environmental reasons), even if some modifications are considered to be safe.

Various physical modifications are thus proposed, for example:
heat moisture treatment (HMT), consisting of treating the starch at controlled moisture levels (22-27%) and at high temperature, for 16 hours, in order to alter the structure and physicochemical properties of the starch;
annealing, consisting of treating the starch in an excess of water at temperatures below the gelatinization temperature, in order to come close to the glass transition temperature;
high-pressure processing (HPP), by means of which the amorphous regions of the starch granule are hydrated, leading to a distortion of the crystalline parts of the granule and promoting the accessibility of said crystalline regions to water;
glow discharge plasma treatment, which generates, at ambient temperature, high-energy electrons and other highly active species. Applied to the starch, these active species excite the chemical groups in the starch and cause significant crosslinking of the macromolecules;
osmotic pressure treatment (OPT), carried out in the presence of solutions with a high content of salts. The starch is suspended in sodium sulfate in order to produce a uniform suspension. The starch passes from type B to type A after treatment, thus acquiring a gelatinization temperature which significantly increases;
“thermal inhibition” treatment. Generally, thermal inhibition means dehydrating a starch until it reaches the anhydrous or substantially anhydrous state (i.e. <1% moisture content), then a thermal treatment at more than 100° C. for a sufficient period of time to “inhibit” the starch, in this case to afford it properties of crosslinked starches. Moreover, it is necessary to place the starch under pH conditions which are at least neutral to preferentially alkaline, before carrying out the step of forced dehydration. An alternative to “thermal inhibition” treatment has been proposed in the solvent phase and consists of heating a non-pre-gelatinized granular starch in an alcohol-based medium in the presence of a base and salts at a temperature of 120 to 200° C. for 5 minutes to 2 hours.

Regardless, the thermal inhibition process thus leads to obtaining a starch paste having properties of increased resistance to viscosity breakdown, and a non-cohesive texture.

The technical field to which the invention belongs is that of thermal inhibition treatment of starch without an aqueous-alcoholic solvent.

In this particular technical field, mention may more particularly be made of U.S. Pat. No. 6,221,420, which describes a thermally inhibited starch obtained by dehydration then thermal treatment.

The main steps are:
dehydration of the starch to a water content of less than 1%, carried out at a temperature comprised between 100 and 125° C., then
heat treatment of the dry starch thus obtained, at approximately 140° C., in a reactive fluidized bed, for a duration of the order of 20 hours.

Preferentially, before the step of dehydrating the starch, it is recommended to perform a step of alkalinization of the starch, making it possible to bring the pH of the starch suspension to a value comprised between 7 and 10, preferably comprised between 8 and 10.

At this stage, before the step of dehydration proper which precedes the inhibition step, the water content of the starch (as demonstrated by way of examples) is then comprised between 8 and 10%.

Patent application US 2001/0017133 describes a similar method, wherein the starch is also dehydrated below 125° C. before the inhibition process is begun (at a temperature higher than 100° C., preferentially comprised between 120 and 180° C., more preferentially comprised between 140 and 160° C.) for a duration of up to 20 hours, preferentially comprised between 3 hours, 30 minutes and 4 hours, 30 minutes.

Before the dehydration step, the conventional alkalinization step leads to a starch suspension having a pH value comprised between 7.5 and 11.2, preferably comprised between 8 and 9.5%, and a water content comprised between 2 and 15%.

A variant was proposed in patent application WO 2014/042537, said variant relating to heating a starch that had undergone an alkalinization treatment to temperatures comprised between 140 and 190° C. while ensuring that the inhibition method is initiated and carried out in the presence of a sufficient amount of water, that is more than 1% water.

In other words, this method recommends the thermal inhibition of a starch which has been alkalinized beforehand without carrying out a dehydration step.

The starch preparation or the starch is thus brought to a pH comprised between 9.1 and 11.2, preferentially to a value of the order of 10, and the moisture content is adjusted to between 2 and 22%, preferentially between 5 and 10%.

The thermal inhibition is subsequently carried out directly on this powder or this starch, at a temperature comprised between 140 and 190° C., preferentially between 140 and 180° C., for a duration of 30 minutes.

The applicant company has developed its own method for preparing heat-modified starches, method which is described in its application WO 2019/122749, consisting in:
(i) preparing a starch milk having a dry matter content comprised between 30 and 40%, preferably between 35 and 37% by weight,
(ii) adding an alkaline agent so as to obtain a final conductivity comprised between 0.7 and 2.5 mS/cm,
(iii) ensuring a contact time comprised between 0.5 and 5 hours,
(iv) filtering and drying the starch milk,
(v) heating the dried starch so as to bring it to a temperature higher than 180° C. for a residence time comprised between 12 and 35 minutes.

The technological advantage is undeniable. It not only makes it possible to considerably reduce the reaction time, but also makes it possible to treat starches of all botanical sources. However, even if it is observed that the texturizing power of these products is satisfactory, it may be noted that the viscosity properties developed by the heat-modified starches by this technology can be further improved.

In the prior art, different alternatives are presented to improve the technological properties of thermally inhibited (or heat-modified) starches.

A first alternative consists of producing blends of starches with other carbohydrates (oligosaccharides, cellulose, even other native or modified starches) before or after the heat treatment to improve the strength properties (texture and/or viscosity).

Thus, in patent EP 1,102,792, it is proposed to dope the starch in the presence of oligosaccharides having 1 to 20 sugar units.

Under certain implementation conditions, the blend of starch and oligosaccharides then develops better stability to cold storage.

However, for certain food applications, heavy purification steps must be added to remove the oligosaccharides from the starch after thermal treatment.

In patent EP 2,251,358, it is preferred to use a powder blend of starch and hemicellulose soluble in water, in particular proportions.

The thermal treatment consists in a heat moisture treatment at a temperature of 100 to 200° C.

It is further recommended to incorporate sodium carbonate (or similar alkaline compounds) with hemicellulose into tapioca, glutinous rice or waxy corn starch.

However, a method for modifying starch is especially sought such that the swelling and/or disintegration (for example, rupture) of the starch granules are effectively suppressed without any chemical treatment.

According to this patent, the aim is not to improve per se the technological properties of the starch thus heat-modified, but to prevent gelatinization of the starch for the manufacture of pastry creams.

It is also known to produce blends of starches in order to optimize their functional properties, but this is done by blending heat-modified starch varieties with native starches as described in international application WO 2020/018061.

This international application indeed describes a starched composition comprising:
A heat moisture treated (HMT) potato starch in an amount varying between 60 and 70% by weight of the total starched composition and
A native tapioca starch in an amount comprised between 30 and 40% by weight of the composition of the total starched composition.

Or else, if the blend is thermally treated, it is especially recommended for blends of starches with binding agents. As described for example in patent application EP 3 345 932, wherein a starch of a given botanical origin is selected, mixed with a starch of the same botanical origin but treated enzymatically or chemically.

In the same spirit, the applicant company has developed its own technology, described in French patent application FR 20 07801 filed on 24 Jul. 2020 and not yet published, consisting of a method for heat treatment of a blend of at least two granular starches of distinct botanical origins.

According to that application, the method for preparing a blend of at least two heat-modified starches, wherein the starches are granular starches of different botanical origins, comprises the steps consisting of:
(i) preparing a starch milk containing at least two starches of different botanical origins, having total dry matter content comprised between 30 and 40%, and preferably between 35 and 37% by weight,
(ii) adding an alkaline agent so as to obtain a final conductivity of the powder resuspended to 20% dry matter content of between 0.5 and 5 mS/cm,
(iii) ensuring a contact time comprised between 0.5 and 5 hours,
(iv) filtering and drying the starch milk to a moisture content comprised between 10.5 and 15%, so as to obtain a starch powder having a conductivity of between 0.5 and 2.5 mS/cm and a pH comprised between 9 and 10.5,
(v) heating the dried starch powder so as to bring it to a temperature higher than 130° C., preferably between 130 and 220° C., for a residence time comprised between 10 minutes and 6 hours.

The Applicant company had found that one of the main limitations of heat-modified starches manufactured from a single botanical source is a developed viscosity slightly lower than that of the commercially available chemically modified starches, requiring overdosing in the event of replacement in the context of a solution that has 100% natural status and “with the least possible chemical transformation” (“clean label”).

This new technology based on blends thus appears as a simple and efficient solution.

A second alternative to improve the technological properties of thermally inhibited starches consists of combining several distinct heat treatment methods.

Whereas all of the methods described above are intended to retain the granular structure of the starch or starches treated in such a way as to prevent gelatinization of the starch, the technology recommended in this second alternative consists, on the contrary, in combining gelatinization and heat treatment of the starch, which will lead to increasing the solubility of the products obtained.

Indeed, the native starch granules are insoluble in cold water. However, when the native granules are dispersed in water and heated, they hydrate and swell. With continuous heating, shearing or extreme pH conditions, the gelatinized granules are fragmented and the starch molecules are dispersed in water, that is to say solubilized. This is called pregelatinized starch.

“Pregelatinized” starch or “pregel” starch is understood to mean a starch obtained by hydrothermal gelatinization treatment of native starches or modified starches, in particular by steam cooking, jet-cooking, drum baking or kneading-machine baking, at a temperature below the gelatinization temperature of the corresponding starch, then drying in starch form on a drying drum or in an extruder, making the starch soluble in cold water.

Thus, U.S. Pat. No. 6,261,376 describes this treatment to obtain pregelatinized non-granular starches having the texturing properties of chemically crosslinked non-granular pregelatinized starches, and free of foul taste.

To do this, this patent teaches performing pregelatinization on starch or flours previously or not thermally inhibited.

In other words, in an undifferentiated manner, there is a thermal inhibition of a variety of native starch, then to its pregelatinization, or alternatively, a variety of starch is first pregelatinized, then thermally inhibited.

These methods are implemented on any botanical source of starch, always chosen to be unique and lead to ensuring that the starches thus treated have a high degree of inhibition and a high viscosity peak.

No information is presented in this document relating to the solubility of the products obtained, nor to the best way to balance their solubility and viscosity, while maintaining an equivalent or even greater level of resistance to chemically stabilized starches.

Thus, there remains an unsatisfied need to have a new alternative to these prior art methods, and the applicant company has found that this need is satisfied by choosing to combine its heat-modified starch production technology from a blend of at least two starches of distinct botanical origins and of gelatinization of the heat-modified starch blend thus obtained.

The order of the steps is therefore contrary to what was recommended in U.S. Pat. No. 6,261,376, that is to say to choose to implement the gelatinization step after having obtained the blend of heat-modified starches, and not the reverse. Thus, the present invention requires:
carrying out a first step of heat treatment of the thermal inhibition type on a blend of starches from distinct botanical sources, followed by
a second step of pregelatinization of the starch blend thus modified.

### DESCRIPTION OF THE INVENTION

According to a first aspect of the invention, the method for preparing a gelatinized blend of at least two heat-modified starches, wherein the starches are starches of different botanical origins, comprises the steps consisting of:
1. Preparing a starch milk containing at least two starches of distinct botanical origins,
2. Treating the milk thus obtained under alkaline conditions and then dehydration and heat treatment for a time and at a temperature making it possible to obtain a blend of heat-modified starches,
3. Pregelatinizing said blend using a method that causes a break in the granular structure of the starches.

Preferably, the first two steps will be carried out as follows:
(i) preparing a starch milk containing at least two starches of different botanical origins, having total dry matter content comprised between 30 and 40%, and preferably between 35 and 37% by weight,
(ii) adding an alkaline agent so as to obtain a final conductivity of the powder resuspended to 20% dry matter content of between 0.5 and 5 mS/cm,
(iii) ensuring a contact time comprised between 0.5 and 5 hours,
(iv) filtering and drying the starch milk to a moisture content comprised between 10.5 and 15%, so as to obtain a starch powder having a conductivity of between 0.5 and 2.5 mS/cm and a pH comprised between 9 and 10.5,
(v) heating the dried starch powder so as to bring it to a temperature higher than 130° C., preferably between 130 and 220° C., for a residence time comprised between 10 minutes and 6 hours.

The starches to be used in the method of the invention may be of any origin, for example corn, waxy corn, amylomaize, wheat, waxy wheat, pea, faba bean, potato, waxy potato, tapioca, waxy tapioca, rice, konjac, etc.

Preferentially, it is selected to blend a potato starch with a corn starch, more particularly waxy corn starch (with high amylopectin content).

According to a particular embodiment, the method according to the invention relates to the preparation of a blend of two heat-modified starches, wherein the starches are granular starches of distinct botanical origins, present in the blend in equal amounts, thus forming a 50/50 blend by weight.

The method according to the invention requires in step (i) preparing a starch milk of at least two different botanical origins having total dry matter content comprised between 30 and 40%, preferably between 35 and 37% by weight. As will be demonstrated by way of examples below, the dry matter content is set to 36.5% by weight.

The next step (ii) then consists in controlling the alkaline impregnation of the blended starches.

The alkaline agent is preferentially selected from the group consisting of sodium hydroxide, sodium carbonate, tetrasodium pyrophosphate, ammonium orthophosphate, disodium orthophosphate, trisodium phosphate, calcium carbonate, calcium hydroxide, potassium carbonate, and potassium hydroxide, or a mixture of two or more of them, and even more preferentially sodium carbonate.

Alkaline impregnation with sodium carbonate is carried out by adding the alkaline agent, for example in powder form, to obtain a final conductivity on the powder resuspended to 20% dry matter content comprised between 0.5 and 5 mS/cm.

In step (iii), a contact time comprised between 0.5 and 5 hours, preferably between 0.5 and 1 hour, is then ensured.

The conductivity, pH and humidity setpoints of the blended starch powder before heat treatment (step (iv)) are as follows:
Conductivity: comprised between 0.5 and 2.5 mS/cm,
pH: between 9.5 and 10.5.
humidity: between 10.5 and 15%.

In a first embodiment of the method according to the invention, the next thermal treatment step itself in step (v) can be carried out in thermal treatment devices combining the heat exchanges by conduction and by convection, a device of the turbo-dryer type, for example at least one VOMM-type continuous turbo-dryer, which thus makes it possible, depending on the size of said VOMM, to achieve a very short reaction time, of the order of a few minutes, i.e. less than 5 minutes per thermal treatment stage.

The temperature setpoints are then set to values of more than 190° C., preferably comprised between 200 and 210° C., for a residence time comprised between 10 and 60 minutes, even more preferentially between 15 and 35 minutes.

The delta T, defined as the difference in temperature between the setpoint temperature and the temperature of the product at the outlet of the reactor, is between 17 and 27° C.

In a second embodiment of the method according to the invention, the actual thermal treatment can be carried out in devices of the “reaction fluidized bed” type.

As is known to the skilled person, this device consists of a reactor which makes it possible to suspend a divided solid by means of a gas, in this case an air/nitrogen blend. The speed of the gas is adjusted depending on the raw material.

The thermal treatment temperature (temperature of the product) is between 130 and 200° C. with a reaction time varying between 30 min and 6 hours, preferentially between 2 and 4 hours.

Preferably, step 3) of the method according to the invention, which consists of pregelatinizing the blend of heat-modified starches, uses a method that causes a breakdown in the granular structure of the starches.

Pregelatinization is carried out by any means known to the person skilled in the art, by hydrothermal gelatinization treatment, in particular by steam cooking, jet-cooking, drum baking or kneading-machine baking, at a temperature below the gelatinization temperature of the corresponding starch, then drying in starch form on a drying drum or in an extruder, making the starch soluble in cold water.

Pregelatinization is preferentially carried out in the following way:
(i) Suspending the heat-modified starch blend with a dry matter of between 25 and 35%, preferably 30% by weight,
(ii) Feeding a drying drum and heating the starch milk to a temperature between 100 and 120° C., preferably between 108 to 110° C.,
(iii) Crushing the sheet obtained so as to obtain a powder having an average particle size of between 50 and 60 μm.

The gelatinized blend of heat-modified starches according to the invention will advantageously be used, as a function of their respective properties, as thickening agents and texturing agents in numerous food applications, mainly in instant soups, sauces, vinaigrettes, desserts, dairy products, and baking supplies.

Thus, according to a second aspect, the invention relates to a gelatinized blend of at least two heat-modified starches, wherein the starches are starches of distinct botanical origins, said blend being capable of being obtained by a manufacturing method according to the first aspect.

Thus, according to a third aspect, the invention relates to the use of a heat-modified starch produced by the method according to the first aspect, as thickening agents and texturing agents in food applications, mainly in instant soups, sauces, vinaigrettes, desserts, dairy products and baking supplies.

The invention will be better understood with the aid of the following examples, which are intended to be illustrative and non-limiting.

### EXAMPLES

### Materials and Methods

### Measurement of Conductivity

The method implemented herein is adapted from the European Pharmacopoeia—current official edition—Conductivity (§ 2.2.38).

### Equipment:

KNICK 703 electronic conductivity meter, also equipped with its measuring cell and verified according to the procedure described in its instruction manual.

### Procedure:

A solution containing 3 g of sample in powder form and 97 g of distilled water having a resistivity of greater than 500,000 ohms·cm is prepared.

The measurement is carried out at 20° C. using the conductivity meter, referring to the procedure indicated in the instrument's user manual.

The values are expressed in microsiemens/cm (μS/cm).

### Measuring the Viscosity of a Starch Suspension Using the Rapid Viscometer Analyzer (RVA)

This measurement is carried out under predetermined concentration conditions and according to a suitable temperature/time analysis profile.

The procedure is as follows:
Introduce 4.30 g±0.01 g of glycerin, directly in the viscometer bowl (ref. NEW 970028-FOSS).
Weigh the sample to be tested, to the exact mg, on the precision scale, directly in the viscometer bowl.
Homogenize the assembly with a microspatula. Recover as much product as possible using the stirrer blade.
In a 50 mL beaker, weigh 6.00 g of citric acid solution monohydrate (10% by weight solution) and 20.00 g of distilled water. The weighing is carried out on a precision scale.
Pour the previously weighed water/citric acid solution blend into the glycerin/sample blend and immediately start the measurement.

The time/temperature and speed analysis profile in the RVA is then carried out as follows:

TABLE I

| Time hh:mm:ss | Temperature ° C. | Speed of rotation (RPM) |
|---|---|---|
| 00:00:00 | 25 | 100 |
| 00:00:10 | 25 | 500 |
| 00:00:15 | 25 | 1000 |
| 00:00:30 | 25 | 160 |
| 00:10:00 | 25 | 160 |
| 00:18:00 | 90 | 160 |
| 00:21:00 | 90 | 160 |
| 00:29:00 | 30 | 160 |
| 00:34:00 | 30 | 160 |

End of test: 00:34:05 (hh:mm:ss)
Initial temperature: 25° C.±0.5° C.
Data acquisition interval: 2 seconds
Sensitivity: low

The results of the measurements are given in RVU (unit used to express the viscosity obtained on the RVA), it being known that 1 RVU unit=12 cPoises (cP).

As a reminder, 1 cP=1 mPa·s.

The results will therefore be presented in mPa·s.

### Measurement of Solubility

### Procedure for Measuring the Solubility of a Native Starch:

In a 250 mL beaker, 200 mL of distilled water is introduced. Begin stirring and add 50 g of the sample to be analyzed. Homogenize for 15 minutes and centrifuge for 10 minutes at 4000 rpm.
Take 50 mL of the supernatant liquid. Introduce it into a tared dish (previously dried for 1 hour in an air circulation oven set to 103° C.+/−2° C.).
Place at 60° C. in another aerated oven allowing drying at 50-60° C., until the water is evaporated.
Then, in the air circulation oven set at 103° C.+/−2° C. for 1 hour.
Place in a desiccator to cool to room temperature.
Weigh.

### Procedure for Measuring the Solubility of a Gelatinized Starch:

In a 250 mL beaker, 200 mL of distilled water is introduced. Begin stirring and add 5 g of the sample to be analyzed. Homogenize for 15 minutes and centrifuge for 10 minutes at 4000 rpm.
Take 25 mL of the supernatant liquid. Introduce it into a tared dish (previously dried for 1 hour in an air circulation oven set to 103° C.+/−2° C.).
Place at 60° C. in another aerated oven allowing drying at 50-60° C., until the water is evaporated.
Then, in the air circulation oven set at 103° C.+/−2° C. for 1 hour.
Place in a desiccator to cool to room temperature.
Weigh.

The content of soluble materials, expressed as percentage by mass, is given by the formula:

$$= \frac{m \times 200 \times 1000}{25 \times P} where$$

m=the mass in grams of the residue
P=the mass in grams of the test specimen.

### Example 1: Preparation of a Blend of Native Starch Followed by Pregelatinization on a Drying Drum

Preparing a 50/50 wt. % aqueous suspension of waxy corn starch and potato starch, with 30% dry matter (DM),
Feeding the drum from the manufacturer “Andritz Gouda” at a rotational speed of 4 rpm at the start and the cylinders of which are heated to 90° C. by steam at 8.6 bar. A solid starch sheet is thus obtained. A nozzle is also used to heat the starch milk to 108-110° C.
Increasing the rotational speed to 6 rpm to obtain more regular glops.
Obtaining a homogeneous sheet at the outlet of the drying drum.

The sheet is then ground in a hammer mill from the manufacturer “Retsch” equipped with a 5 mm grid, at 1500 rpm, and then in an ultra fine mill of the brand “Septu” set to 50 Hertz, at a rotational speed of 3000 rpm. This results in a fine yellowish powder. The average diameter by volume of this powder is 68 μm.

TABLE II
Results:

| | | | | RVA | | | | |
|---|---|---|---|---|---|---|---|---|
| | Humidity | pH at | Conductivity | Peak V | V24 min | Vmini | Peak | Solubility |
| Exp | % | 3% DM | at 3% μS | (mPa · s) | (mPa · s) | (mPa · s) | T° C. | % |
| T0 | 6.9 | 6.5 | 45.2 | 204 | 39 | 34 | 42.2 | 88.7 |

### Example 2: Preparation of a Blend of Heat-Modified Starches a in a VOMM Continuous Turbo-Dryer Followed by Pregelatinization on a Drying Drum

### 1) the Alkalinization of the Starch Blend is Carried Out According to the Following Steps:

Preparing a 50/50 wt. % aqueous suspension of waxy corn starch and potato starch, with 36.5% dry matter (DM);
Adding sodium carbonate in powder form in order to obtain a final conductivity on the powder resuspended to 20% DM of between 0.5 and 1 mS/cm;
Ensuring a contact time of 2 hours;
Filtering and drying to a starch equilibrium moisture content of between 10-14%

It is quite possible, instead of adding sodium carbonate in powder form, to add it in solution form according to the following protocol:
Prepare an aqueous solution of sodium carbonate at 30% weight concentration and heat to 40-50° C. to promote the dissolution of the carbonate;
Add the solution of sodium carbonate at 30% weight concentration so as to obtain a conductivity on the milk comprised between 2 and 4 mS/cm;
Ensure a contact time of 30 min.

This makes it possible to reduce the contact time since the carbonate is already well dissolved in solution at 30%.

### 2) Thermal Treatment

The product obtained in the previous step is heat-treated in VOMM-type continuous turbo-dryers in series, the setpoint temperature of which is set to 210° C. and which are configured to subject the product to a residence time of 30 min and such that the temperature difference between the setpoint and the temperature of the product at the outlet of the reactor, referred to as delta T, is a value of the order of 21° C.

TABLE III
Process parameters:

| | Conductivity on | Moisture | | | |
|---|---|---|---|---|---|
| | the product after | content of | | | |
| | impregnation, | the product | | | Residence |
| | resuspended to 20% | before thermal | Delta | Setpoint | time |
| Exp | solids, in mS/cm | treatment | T | T ° C. | (min) |
| A | 0.626 | 10 | 21 | 210 | 30 |

The RVA viscosity measurements are carried out and presented in the table below.

TABLE IV
Results:

| Exp | Drop RVA (mPa · s) | Peak RVA (mPa · s) |
|---|---|---|
| 50/50 waxy starch/potato | 990 | 1169 |
| starch base | | |
| A | −158 | 577 |

### 3) Neutralization and Washing

Resuspending the heat-treated blend at 36.5% dry matter in water.
Neutralization with hydrochloric acid diluted to 18% to obtain a pH between 5 and 7.5.
Testing and washing with demineralized water on a “Dorr Oliver” wringer until a conductivity of less than 250 μS is obtained.

The cake thus obtained has a moisture of between 40 and 45%.

### 4) Pregelatinization on a Drying Drum

Resuspending the cake at 30% DM in water
Feeding the drum from the manufacturer “Andritz Gouda” at a rotational speed of 4 rpm at the start and the cylinders of which are heated to 90° C. by steam at 8.6 bar. A solid starch sheet is thus obtained. A nozzle is also used to heat the starch milk to 108-110° C.
Increasing the rotational speed to 6 rpm to obtain more regular glops.
Obtaining a homogeneous sheet at the outlet of the drying drum.

The sheet is then ground in a hammer mill from the manufacturer “Retsch” equipped with a 5 mm grid, at 1500 rpm, and then in an ultra fine mill of the brand “Septu” set to 50 Hertz, at a rotational speed of 3000 rpm. This results in a fine yellowish powder. The average diameter by volume of this powder is 55 μm.

TABLE V
Results:

| | | | | RVA | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | % |
| ATS | 4.9 | 7.2 | 142 | 553 | 184 | 204 | 81.7 | 32.1 |

### Discussion of Results:

If this family A of heat-modified and pregelatinized starch blends is compared to example 1 and therefore to the blend of only pregelatinized starches, it is noted that the temperature at the Peak is much higher for the heat-modified and pregelatinized blend than for the pregelatinized-only blend. This indeed reflects an improved level of resistance for family A relative to the pregelatinized native blend: it is necessary to achieve a greater temperature to completely swell the starch blend. However, this also results in the solubility being reduced.

### Example 3: Preparation of a Blend of Heat-Modified Starches B in a VOMM Continuous Turbo-Dryer Followed by Pregelatinization on a Drying Drum

### 1) the Alkalinization of the Starch Blend is Carried Out According to the Following Steps:

Preparing a 50/50 wt. % aqueous suspension of waxy corn starch and potato starch, with 36.5% dry matter (DM);
Adding sodium carbonate in powder form in order to obtain a final conductivity on the powder resuspended to 20% DM of between 0.5 and 1 mS/cm;
Ensuring a contact time of 2 hours
Filtering and drying to a starch equilibrium moisture content of between 10 and 14%.

It is quite possible, instead of adding sodium carbonate in powder form, to add it in solution form as follows:
Prepare an aqueous solution of sodium carbonate at 30% weight concentration and heat to 40-50° C. to promote the dissolution of the carbonate
Add the solution of sodium carbonate at 30% weight concentration so as to obtain a conductivity on the milk comprised between 2 and 4 mS/cm;
Ensure a contact time of 30 min.

This makes it possible to reduce the contact time since the carbonate is already well dissolved in solution at 30%.

### 2) Thermal Treatment

The product obtained in this way is heat-treated in VOMM-type continuous turbo-dryers in series, the setpoint temperature of which is set to 210° C. and which are configured to subject the product to a residence time of 35 to 40 min and such that the temperature difference between the setpoint and the temperature of the product at the outlet of the reactor, referred to as Delta T, is a value of the order of 24 to 25° C.

TABLE VI
Process parameters:

| | Conductivity on | | | | |
|---|---|---|---|---|---|
| | the product after | Moisture | | | |
| | impregnation, | content of the | | | |
| | resuspended | product before | | | Residence |
| | to 20% solids, | thermal | | Setpoint | time |
| Exp | in mS/cm | treatment | Delta T | T° C. | (min) |
| B-1 | 0.630 | 10 | 24 | 210 | 35 |
| B-2 | 0.595 | 10.1 | 25 | 210 | 40 |

The RVA viscosity measurements are carried out and presented in the table below.

TABLE VII
Results:

| Exp | Drop RVA (mPa · s) | Peak RVA (mPa · s) |
|---|---|---|
| 50/50 waxy starch/potato | 990 | 1169 |
| starch base | | |
| B-1 | −386 | 648 |
| B-2 | −497 | 469 |

### 3) Neutralization and Washing

Resuspending the heat-treated blends at 36.5% dry matter in water.
Neutralization with hydrochloric acid diluted to 18% to obtain a pH between 5 and 7.5.
Testing and washing with demineralized water on a “Dorr Oliver” wringer until a conductivity of less than 250 μS is obtained.
The cake thus obtained has a moisture of between 46 and 50%.

### 4) Pregelatinization on a Drying Drum

Resuspending the cake at 30% DM in water
Feeding the drum from the manufacturer “Andritz Gouda” at a rotational speed of 4 rpm at the start and the cylinders of which are heated to 90° C. by steam at 8.4 bar. A solid starch sheet is thus obtained. A nozzle is also used to heat the starch milk to 114-118° C.
Increasing the rotational speed to 5 rpm to obtain more regular glops.
Obtaining a homogeneous sheet at the outlet of the drying drum.
The sheet is then ground in a hammer mill from the manufacturer “Retsch” equipped with a 5 mm grid, at 1500 rpm, and then in an ultra fine mill of the brand “Septu” set to 50 Hertz, at a rotational speed of 3000 rpm. This results in a fine yellowish powder. The average diameter by volume of this powder is 54 μm.

TABLE VIII
Results:

| | | | | RVA | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | % |
| B-1 TS | 5.05 | 7.3 | 130 | 404 | 218 | 222 | 88.85 | 30.6 |
| B-2 TS | 4.47 | 7.5 | 250 | 409 | 192 | 188 | 86.75 | 30 |

### Discussion of Results:

If this family B of heat-modified and pregelatinized starch blends is compared to examples 1 and 2 (Family A), it is noted that the temperature at Peak is much higher for family B than for the pregelatinized-only blend and also higher than family A. This clearly reflects an improved level of resistance of family B compared to family A and to the pregelatinized native blend: it is necessary to achieve a greater temperature to completely swell the starch blend. However, this also results in the solubility being a bit further reduced.

### Example 4: Preparation of a Blend of Heat-Modified Starches C in a VOMM Continuous Turbo-Dryer Followed by Pregelatinization on a Drying Drum

### 1) the Alkalinization of the Starch Blend is Carried Out According to the Following Steps:

Preparing a 50/50 wt. % aqueous suspension of waxy corn starch and potato starch, with 36.5% dry matter (DM);
Adding sodium carbonate in powder form in order to obtain a final conductivity on the powder resuspended to 20% DM of between 0.5 and 1 mS/cm;
Ensuring a contact time of 2 hours;
Filtering and drying to a starch equilibrium moisture content of between 10 and 14%

It is quite possible, instead of adding sodium carbonate in powder form, to add it in solution form as follows:
Prepare an aqueous solution of sodium carbonate at 30% weight concentration and heat to 40-50° C. to promote the dissolution of the carbonate;
Add the solution of sodium carbonate at 30% weight concentration so as to obtain a conductivity on the milk comprised between 2 and 4 mS/cm;
Ensure a contact time of 30 min.

This makes it possible to reduce the contact time since the carbonate is already well dissolved in solution at 30%.

### 2) Thermal Treatment

The product obtained in this way is heat-treated in VOMM-type continuous turbo-dryers in series, the setpoint temperature of which is set to 210° C. and which are configured to subject the product to a residence time of 45 to 50 min and such that the temperature difference between the setpoint and the temperature of the product at the outlet of the reactor, referred to as delta T, is a value of the order of 22 to 25° C.

TABLE IX
Process parameters:

| | Conductivity on | | | | |
|---|---|---|---|---|---|
| | the product after | Moisture | | | |
| | impregnation, | content of the | | | |
| | resuspended | product before | | | Residence |
| | to 20% solids, | thermal | | Setpoint | time |
| Exp | in mS/cm | treatment | Delta T | T° C. | (min) |
| C | 0.605 | 10.3 | 25 | 210 | 45 |

The RVA viscosity measurements are carried out and presented in the table below.

TABLE X
Results:

| Exp | Drop RVA (mPa · s) | Peak RVA (mPa · s) |
|---|---|---|
| 50/50 waxy starch/potato | 990 | 1169 |
| starch base | | |
| C | −504 | 345 |

### 3) Neutralization and Washing

Resuspending the heat-treated blend at 36.5% dry matter in water.
Neutralization with hydrochloric acid diluted to 18% to obtain a pH between 5 and 7.5.
Testing and washing with demineralized water on a “Dorr Oliver” wringer until a conductivity of less than 250 μS is obtained.
The cake thus obtained has a moisture of between 50 and 58%.

### 4) Pregelatinization on a Drying Drum

Resuspending the cake at 30% DM in water
Feeding the drum from the manufacturer “Andritz Gouda” at a rotational speed of 4 rpm at the start and the cylinders of which are heated to 90° C. by steam at 8.1 bar. A solid starch sheet is thus obtained. A nozzle is also used to heat the starch milk to 114° C.
Regular glops are obtained without increasing the rotational speed.
Obtaining a thin homogeneous sheet at the outlet of the drying drum.

The sheet is then ground in a hammer mill from the manufacturer “Retsch” equipped with a 5 mm grid, at 1500 rpm, and then in an ultra fine mill of the brand “Septu” set to 50 Hertz, at a rotational speed of 3000 rpm. This results in a fine yellowish powder. The average diameter by volume of this powder is 52 μm.

TABLE XI
Results:

| | | | | RVA | | | | |
|---|---|---|---|---|---|---|---|---|
| | Humidity | pH at | Conductivity | Peak V | V24 min | Vmini | Peak | Solubility |
| Exp | % | 3% DM | at 3% μS | (mPa · s) | (mPa · s) | (mPa · s) | T° C. | % |
| C-1 TS | 4.1 | 5.08 | 85 | 392 | 203 | 195 | 90 | 27.4 |

### Discussion of Results:

If this family C of heat-modified and pregelatinized starch blends is compared to examples 1, 2 (Family A) and 3 (Family B), it is noted that the temperature at Peak (RVA MCL107F) is much higher for family C than for the pregelatinized-only blend and also higher than family A and family B. This clearly reflects an improved level of resistance of family C compared to family B, family A, and to the pregelatinized native blend: it is necessary to achieve a greater temperature to completely swell the starch blend. However, this also results in the solubility being a bit further reduced.

### Example 5: Preparation of a Heat-Modified Waxy Corn Starch W in a VOMM Continuous Turbo-Dryer Followed by Pregelatinization on a Drying Drum

### 1) The Alkalinization of the Waxy Corn Starch is Carried Out According to the Following Steps:

Prepare an aqueous suspension of waxy corn starch at 36.5% by weight of dry matter (DM)
Prepare a solution of sodium carbonate at 30% weight concentration and heat to 40-50° C. to promote the dissolution of the carbonate
Add the sodium carbonate solution to a weight concentration of 30% so as to obtain a conductivity on the milk of between 4 and 7 mS/cm;
Ensure a contact time of 0.5
Filtering and drying to a starch equilibrium moisture content of between 10-14%

### 2) Thermal Treatment.

The product obtained in this way is heat-treated in VOMM-type continuous turbo-dryers in series, the setpoint temperature of which is set to 210° C. and which are configured to subject the product to a residence time of 35 min and such that the temperature difference between the setpoint and the temperature of the product at the outlet of the reactor, referred to as Delta T, is a value of the order of 17 to 20° C.

TABLE XII
Process parameters:

| | Conductivity on | | | | |
|---|---|---|---|---|---|
| | the product after | Moisture | | | |
| | impregnation, | content of the | | | |
| | resuspended | product before | | | Residence |
| | to 20% solids, | thermal | | Setpoint | time |
| Exp | in mS/cm | treatment | Delta T | T° C. | (min) |
| W | 1 | 11.8 | 18 | 210 | 35 |

The RVA viscosity measurements are carried out and presented in the table below.

TABLE XIII
Results:

| Exp | Drop RVA (mPa · s) | Peak RVA (mPa · s) |
|---|---|---|
| W | −150 | 230 |

### 3) Neutralization and Washing

Resuspending the heat-treated blend at 36.5% of dry matter in aqueous suspension.
Neutralization with hydrochloric acid diluted to 18% to obtain a pH between 5 and 7.5.
Testing and washing with demineralized water on a “Dorr Oliver” wringer until a conductivity of less than 250 μS is obtained.
The cake thus obtained has a moisture of between 45 and 50%.

### 4) Pregelatinization on a Drying Drum

Resuspending the cake at 30% DM in water
Feeding the drum from the manufacturer “Andritz Gouda” at a rotational speed of 5 rpm at the start and the cylinders of which are heated to 90° C. by steam at 8 bar. A solid starch sheet is thus obtained. A nozzle is also used to heat the starch milk to 110° C.
Regular glops are obtained without increasing the rotational speed.
Obtaining a thin homogeneous sheet at the outlet of the drying drum.

The sheet is then ground in a hammer mill from the manufacturer “Retsch” equipped with a 2 mm grid, at 1500 rpm, and then in an ultra fine mill of the brand “Septu” set to 50 Hertz, at a rotational speed of 3000 rpm. This results in a fine yellowish powder. The average diameter by volume of this powder is 45 μm.

TABLE XIV
Results:

| | | | | RVA | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | % |
| W-1 TS | 5.4 | 5.6 | 171 | 386 | 141 | 129 | 84.55 | 16.5 |

### Discussion of Results:

If this heat-modified and pregelatinized waxy corn starch is compared to its equivalent as a blend (Family B-35 min of residence time), it is possible to note that the resistance seems equivalent (peak temperature around 84° C. versus 88° C. for blends), but higher solubility for the blends and is therefore improved.

### Example 6: Preparation of a Heat-Modified Potato Starch F in VOMM Continuous Turbo-Dryer Followed by Pregelatinization on a Drying Drum

### 1) The Alkalinization of the Potato Starch is Carried Out According to the Following Steps:

Prepare an aqueous suspension of potato starch at 36.5% by weight of dry matter (DM)
Prepare an aqueous solution of sodium carbonate at 30% weight concentration and heat to 40-50° C. to promote the dissolution of the carbonate;
Add the solution of sodium carbonate so as to obtain a conductivity on the milk of between 4 and 6 mS/cm;
Ensure a contact time of 0.5 h; —Filter and dry to a starch equilibrium moisture content of between 12-18%

### 2) Thermal Treatment

The product obtained in this way is heat-treated in VOMM-type continuous turbo-dryers in series, the setpoint temperature of which is set to 210° C. and which are configured to subject the product to a residence time of 45 min and such that the temperature difference between the setpoint and the temperature of the product at the outlet of the reactor, referred to as Delta T, is a value of the order of 20 to 23° C.

TABLE XV
Process parameters:

| | Conductivity on | | | | |
|---|---|---|---|---|---|
| | the product after | Moisture | | | |
| | impregnation, | content of the | | | |
| | resuspended | product before | | | Residence |
| | to 20% solids, | thermal | | Setpoint | time |
| Exp | in mS/cm | treatment | Delta T | T° C. | (min) |
| F | 0.96 | 12 | 22.5 | 210 | 45 |

The RVA viscosity measurements are carried out and presented in the table below.

TABLE XVI
Results:

| Exp | Drop RVA (mPa · s) | Peak RVA (mPa · s) |
|---|---|---|
| F | −415 | 178 |

### 3) Neutralization and Washing

Resuspending the heat-treated blend at 36.5% of dry matter in aqueous suspension.
Neutralization with hydrochloric acid diluted to 18% to obtain a pH between 5 and 7.5.
Testing and washing with demineralized water on a “Dorr Oliver” wringer until a conductivity of less than 250 μS is obtained.
The cake thus obtained has a moisture of between 45 and 50%.

### 4) Pregelatinization on a Drying Drum

Resuspending the cake at 30% DM in an aqueous suspension
Feeding the drum from the manufacturer “Andritz Gouda” at a rotational speed of 4 rpm at the start and the cylinders of which are heated to 90° C. by steam at 8 bar. A solid starch sheet is thus obtained. A nozzle is also used to heat the starch milk to 110° C.
Regular glops are obtained without increasing the rotational speed.
Obtaining a homogeneous sheet at the outlet of the drying drum.
The sheet is then ground in a hammer mill from the manufacturer “Retsch” equipped with a 5 mm grid, at 1500 rpm, and then in an ultra fine mill of the brand “Septu” set to 50 Hertz, at a rotational speed of 3000 rpm. This results in a fine yellowish powder. The average diameter by volume of this powder is 55 μm.

TABLE XVII
Results:

| | | | | RVA | | | | |
|---|---|---|---|---|---|---|---|---|
| | Humidity | pH at | Conductivity | Peak V | V 24 min | V mini | Peak | Solubility |
| exp | % | 3% DM | at 3% μS | (mPa · s) | (mPa · s) | (mPa · s) | T° C. | % |
| F-1 TS | 4.63 | 7.35 | 130 | 292 | 161 | 161 | 71.9 | 33.6 |

### Discussion of Results:

If this heat-modified and pregelatinized potato starch is compared to its equivalent as a blend (Family C-45 min of residence time), it is noted that the resistance is lower (peak temperature at 72° C. versus 90° C. for the blend) but the solubility is slightly greater and therefore improved.

Thus, we can observe a quite unique synergy of the blends compared to the native starches and compared to the pregelatinized-only starches: The resistance and solubility are improved.

### Example 7: Comparison with Chemically Modified and Pregelatinized Starches and Discussion of Results

The test products are modified starch pregels sold by the Applicant company under the generic brand name PREGEFLO®.

The tested products are as follows:

| | | | RVA | | | | |
|---|---|---|---|---|---|---|---|
| | Humidity | pH at | Peak V | V24 min | Vmini | Peak | |
| exp | % | 3% DM | (mPa · s) | (mPa · s) | (mPa · s) | T° C. | Solubility |
| PREGEFLO ® | 8 | 6 | 1827 | 531 | 575 | 68.25 | 7 |
| CH10 | | | | | | | |
| PREGEFLO ® | 5.31 | 5.5 | 1374 | 924 | 923 | 89.6 | 3.8 |
| CH20 | | | | | | | |
| PREGEFLO ® | 5.96 | 5.7 | 1065 | 777 | 776 | 87.7 | 1.8 |
| CH30 | | | | | | | |
| PREGEFLO ® | 7.25 | 5.6 | 921 | 592 | 581 | 80.7 | 2.7 |
| CH40 | | | | | | | |

Discussion: Each starch and heat-modified blend of starches according to the invention has improved stability during the process of use with respect to native starch or native starch blend: less viscosity gain and retrogradation are observed when using these starches.

Therefore, the heat-modified starch blends C represent the products with improved resistance to shearing, to the acidity of the media and to thermal treatments.

The heat-modified starch blends B are a little less resistant than the heat-modified starch blends C and the heat-modified starch blends A are somewhat less resistant than the heat-modified starch blends B.

The choice to use these starch blends will be made based on the intended application and thus on the shear, acidity and implementation temperature conditions.

It is thus noted that the benefit of mixing two starches, and in particular potato starch and waxy corn starch, makes it possible to improve the solubility of the blend relative to the waxy corn starch alone, but also relative to the chemically modified pregels, while maintaining an equivalent or even greater level of resistance than waxy corn starch alone or chemically modified starches.

### Example 8: Preparation of a Heat-Modified Waxy Corn Starch in a Ventilated Oven Followed by Pregelatinization on a Drying Drum

The alkalinization of the waxy corn starch is carried out according to the following steps:
Prepare a waxy corn starch suspension at 36.5% by weight of dry matter (DM)
Prepare a solution of sodium carbonate at 30% weight concentration and heat to 40-50° C. to promote the dissolution of the carbonate;
Add the solution of sodium carbonate at 30% weight concentration so as to obtain a conductivity between 4 and 7 mS/cm for the milk;
Ensure a contact time of 0.5
Filtering and drying to a starch equilibrium moisture content of between 10 and 14%.

### Heat Treatment.

### Equipment Used:

MEMMERT ventilated oven.
Aluminum cup for METTLER LJ16 (moisture measurement scale).
Scale.

### Procedure:

Weigh ˜40 g per aluminum cup of the starch base to be tested.
Place the cups in the MEMMERT oven previously set to 170° C.
Start the chronometer after inserting the cups into the oven.
Then take the cups out of the oven after 1 hour of heat treatment

### Process Parameters

| | Conductivity on the | | | |
|---|---|---|---|---|
| | product after | | | |
| | impregnation, | Moisture | | |
| | resuspended | content of the | | Residence |
| | to 20% solids, | product before | Setpoint | time |
| Exp | in mS/cm | thermal treatment | T° C. | (min) |
| W-2 | 1 | 11.8% | 170 | 60 |

The RVA viscosity measurements are carried out and presented in the table below.

### Results

| Exp | Drop RVA (mPa · s) | Peak RVA (mPa · s) |
|---|---|---|
| W-2 | −110 | 265 |

### Neutralization and Washing

Resuspending the heat-treated waxy corn starch to 36.5% dry matter.
Neutralization with hydrochloric acid 1 N to obtain a pH between 5 and 7.5.
Filtration and washing by percolation with demineralized water on a frit of porosity 3 until a conductivity of less than 250 μS is obtained.
The cake thus obtained has a moisture of between 45 and 50%.

### Pregelatinization on a Drying Drum

Resuspending the cake at 27.5% DM (dry matter)
Feeding the drum from the manufacturer “Simon Dryer” at a rotational speed of 8 rpm at start-up and whose main cylinder is heated by steam at 7 bars. A solid starch sheet is thus obtained.
Regular glops are obtained without increasing the rotational speed.
Obtaining a thin homogeneous sheet at the outlet of the drying drum.
The sheet is then coarsely ground using a Thermomix 3300 Vorweck mill then sieved on a 100 μm mesh. This results in a fine yellowish powder.

### Results

| | | | | RVA MCL107B | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | MCL090A |
| W-2 TS | 6.62 | 5.5 | 43 | 718 | 470 | 498 | 85.85 | 15% |

### Discussion of Results:

A product is obtained similar to that of example 5 in terms of peak temperature (resistance) and solubility but with a higher viscosity.

### Example 9: Preparation of a Heat-Modified Potato Starch in a Ventilated Oven Followed by Pregelatinization on a Drying Drum

The alkalinization of the potato starch is carried out according to the following steps:
Prepare a potato starch suspension at 36.5% by weight of dry matter (DM)
Prepare a solution of sodium carbonate at 30% weight concentration and heat to 40-50° C. to promote the dissolution of the carbonate
Add the solution of sodium carbonate so as to obtain a conductivity on the milk of between 4 and 6 mS/cm;
Ensure a contact time of 0.5 h;
Filter and dry to a starch equilibrium moisture content of between 12-18%

### Heat Treatment.

### Equipment Used:

MEMMERT ventilated oven.
Aluminum cup for METTLER LJ16 (moisture measurement scale).
Scale.

### Procedure:

Weigh ˜40 g per aluminum cup of the starch base to be tested.
Place the cups in the MEMMERT oven previously set to 170° C.
Start the chronometer after inserting the cups into the oven.
Then take the cups out of the oven after 1 hour of heat treatment

### Process Parameters

| | Conductivity on the | | | |
|---|---|---|---|---|
| | product after | | | |
| | impregnation, | Moisture | | |
| | resuspended | content of the | | Residence |
| | to 20% solids, | product before | Setpoint | time |
| Exp | in mS/cm | thermal treatment | T° C. | (min) |
| F-2 | 0.92 | 13.74 | 170 | 60 |

The RVA viscosity measurements are carried out and presented in the table below.

### Results

| Exp | Drop RVA (mPa · s) | Peak RVA (mPa · s) |
|---|---|---|
| Potato starch base | 355 | 720 |
| F-2 | 206 | 1371 |

### Neutralization and Washing

Resuspending the heat-treated potato starch at 30% dry matter.
Neutralization with hydrochloric acid 1 N to obtain a pH between 5 and 7.5.
Filtration and washing by percolation with demineralized water on a frit of porosity 3 until a conductivity of less than 250 μS is obtained.
The cake thus obtained has a moisture of between 45 and 50%

### Pregelatinization on a Drying Drum

Resuspending the cake at 27.5% DM
Feeding the drum from the manufacturer “Simon Dryer” at a rotational speed of 8 to 6 rpm at start-up and whose main cylinder is heated by steam at 7 bars. A solid starch sheet is thus obtained.
Regular glops are obtained after reducing the rotational speed.
Obtaining a homogeneous sheet at the outlet of the drying drum.
The sheet is then coarsely ground using a Thermomix 3300 Vorweck mill then sieved on a 100 μm mesh. This results in a fine yellowish powder.

### Results

| | | | | RVA MCL107B | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | MCL090A |
| F-2 TS | 5.81 | 5.82 | 32 | 534 | 343 | 262 | 73 | 34.9% |

### Discussion of Results:

A product is obtained similar to that of example 6 in terms of peak temperature (resistance) and solubility but with a greater viscosity in particular at startup. After bursting of the non-soluble part, we find a viscosity close to example 6 (161 mPa·s Vmini of example 6 for 262 mPa·s in this example).

### Example 10: Preparation of a Heat-Modified Starch Blend in a Ventilated Oven Followed by Pregelatinization on a Drying Drum

The alkalinization of the starch blend is carried out according to the following steps:
Preparing a suspension of 50/50 wt. % waxy corn starch and potato starch, with 36.5% dry matter (DM);
Prepare a solution of sodium carbonate at 30% weight concentration and heat to 40-50° C. to promote the dissolution of the carbonate
Add the solution of sodium carbonate so as to obtain a conductivity on the milk of between 4 and 6 mS/cm;
Ensure a contact time of 0.5 h;
Filter and dry to a starch equilibrium moisture content of between 12-18%

### Heat Treatment.

### Equipment Used:

MEMMERT ventilated oven.
Aluminum cup for METTLER LJ16 (moisture measurement scale).
Scale.

### Procedure:

Weigh ˜40 g per aluminum cup of the starch base to be tested.
Place the cups in the MEMMERT oven previously set to 170° C.
Start the chronometer after inserting the cups into the oven.
Then take the cups out of the oven after 1 hour of heat treatment

### Process Parameters

| | Conductivity on the | | | |
|---|---|---|---|---|
| | product after | | | |
| | impregnation, | Moisture | | |
| | resuspended | content of the | | Residence |
| | to 20% solids, | product before | Setpoint | time |
| Exp | in mS/cm | thermal treatment | T° C. | (min) |
| M-1 | 1.23 | 11.83 | 170 | 60 |

The RVA viscosity measurements are carried out and presented in the table below.

### Results

| Exp | Drop RVA (mPa · s) | Peak RVA (mPa · s) |
|---|---|---|
| 50/50 waxy starch/potato | 800 | 1023 |
| starch base | | |
| M-1 | −281 | 582 |

### Neutralization and Washing

Resuspending the heat-treated blend at 30% of dry matter.
Neutralization with hydrochloric acid 1 N diluted to 18% to obtain a pH between 5 and 7.5.
Filtration and washing by percolation with demineralized water on a frit of porosity XX until a conductivity of less than 250 μS is obtained.
The cake thus obtained has a moisture of between 45 and 50%

### Pregelatinization on a Drying Drum

Resuspending the cake at 27.5% DM
Feeding the drum from the manufacturer “Simon Dryer” at a rotational speed of 5 rpm at start-up and whose main cylinder is heated by steam at 7 bars. A solid starch sheet is thus obtained.
Regular glops are obtained without increasing the rotational speed.
Obtaining a homogeneous sheet at the outlet of the drying drum.
The sheet is then coarsely ground using a Thermomix 3300 Vorweck Basic mill then sieved on a 100 μm mesh. This results in a fine yellowish powder.

### Results

| | | | | RVA MCL107B | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | MCL090A |
| M-1 TS | 5.44 | 5.55 | 28 | 515 | 357 | 354 | 76 | |

### Discussion of Results:

A product is thus obtained, which, at start-up develops its viscosity in a similar manner to the pregelatinized-only waxy corn starch W-2 but which then approaches the pregelatinized-only starch F-2, having a similar peak temperature.

### Example 11: Comparison of the Results of Example 10 and of the Blend of the Products from Examples 8 and 9

| | | | | RVA MCL107B | | | | |
|---|---|---|---|---|---|---|---|---|
| | Humidity | pH at | Conductivity | Peak V | V24 min | Vmini | Peak | Solubility |
| exp | % | 3% DM | at 3% μS | (mPa · s) | (mPa · s) | (mPa · s) | T° C. | MCL090A |
| A-2 TS | 5.44 | 5.55 | 28 | 515 | 357 | 354 | 76 | 19 |
| 50/50 | 6.20 | 5.63 | 33 | 574 | 343 | 357 | 81 | 23 |
| blend of | | | | | | | | |
| product | | | | | | | | |
| W-2 TS | | | | | | | | |
| and F-2 | | | | | | | | |
| TS | | | | | | | | |

### Discussion of Results:

Depending on whether the blending is performed at the very beginning of the process as claimed in this invention or after having undergone the various processes of heat treatment and pregelatinization separately, the same products are not obtained because the peak temperature is significantly different, which means a different level of resistance and the solubility is also different. In addition, the upstream blend will make it possible to ensure perfect homogeneity, in particular via an identical heat treatment and a pregelatinization under the same conditions. The size of the particles of the pregel thus obtained will also be similar and not lead to segregation over time.

1. A method for preparing a blend of at least two heat-modified starches, wherein the starches are starches of distinct botanical origins, which comprises the steps consisting of:
1. Preparing a starch milk containing at least two starches of distinct botanical origins,
2. Treating the milk thus obtained under alkaline conditions and then dehydration and heat treatment for a time and at a temperature making it possible to obtain a blend of heat-modified starches,
3. Pregelatinizing said blend using a method that causes a break in the granular structure of the starches.

2. The method according to claim 1, wherein the first two steps will be carried out as follows:
(i) preparing a starch milk containing at least two starches of different botanical origins, having total dry matter content comprised between 30 and 40%, and preferably between 35 and 37% by weight,
(ii) adding an alkaline agent so as to obtain a final conductivity of the powder resuspended to 20% dry matter content of between 0.5 and 5 mS/cm,
(iii) ensuring a contact time comprised between 0.5 and 5 hours,
(iv) filtering and drying the starch milk to a moisture content comprised between 10.5 and 15%, so as to obtain a starch powder having a conductivity of between 0.5 and 2.5 mS/cm and a pH comprised between 9 and 10.5,
(v) heating the dried starch powder so as to bring it to a temperature higher than 130° C., preferably between 130 and 220° C., for a residence time comprised between 10 minutes and 6 hours.

3. The method according to claim 1, wherein step 3) is carried out by hydrothermal gelatinization-type treatment, in particular by steam cooking, jet-cooking, drum baking or kneading-machine baking, at a temperature below the gelatinization temperature of the corresponding starch, then drying in starch form on a drying drum or in an extruder.

4. The method according to claim 1, wherein step 3) comprises the steps consisting of:
(i) Suspending the heat-modified starch blend with a dry matter of between 25 and 35%, preferably 30% by weight,
(ii) Feeding a drying drum and heating the starch milk to a temperature between 100 and 120° C., preferably between 108 to 110° C.,
(iii) Crushing the sheet obtained so as to obtain a powder having an average particle size of between 50 and 60 μm.

5. A gelatinized blend of at least two heat-modified starches, wherein the starches are starches of distinct botanical origins, said blend being capable of being obtained by a manufacturing method according to claim 1.

6. Use of a gelatinized blend of at least two heat-modified starches according to claim 5, as thickeners and texturizing agents in numerous food applications, mainly in instant soups, sauces, vinaigrettes, desserts, dairy products, and baking supplies.

7. Use of a gelatinized blend of at least two heat-modified starches according to claim 1, as thickeners and texturizing agents in numerous food applications, mainly in instant soups, sauces, vinaigrettes, desserts, dairy products, and baking supplies.
